(19) United States
(12) Patent Application Publication
(10) Pub. No.: US 2012/0030068 A1
(43) Pub. Date: Feb. 2, 2012

(54) SYSTEM AND METHOD FOR MULTI-USER LISTING, SEARCHING, MATCHING AND TRADING

(76) Inventor: Vernon Thomas, Carlsbad, CA (US)

(21) Appl. No.: 12/847,315

(22) Filed: Jul. 30, 2010

(51) Int. Cl. G06Q 30/00; G06F 15/16; G06F 17/30

(52) U.S. Cl. 705/27.1; 707/770; 709/206; 707/E17.014; 707/E17.032; 705/26.1

(57) ABSTRACT

A system and method is disclosed for allowing users with access to the internet and a computer the ability to post any items they would like to offer by trade, propose a value for those offered items, search for items they would like to receive by trade, which may or may not be currently held in inventory, be notified when potential trades are available and accept or reject items they would like to receive by trade and confirm the trade with at least one other user. Additionally, the system will allow a user to make a direct purchase of items that have been specified as such.

### FIELD OF INVENTION

The present invention relates to the fields of computer systems and internet methodologies. More specifically, the invention relates to the technical field of online and offline multiple user matching for the purpose of trading and/or purchasing items.

### BACKGROUND OF THE INVENTION

Often times, people are in need of an online marketplace that enables them to trade items they have, but don't use or want, for items they really need. This type of venue provides a convenient solution for buyers, sellers and traders while simultaneously maintaining the highest possible value of goods.

Currently, there are systems in place such as Ebay®, which allows users to post items for sale through an auction process. Supposedly, this aids the user in getting the highest possible value for their item. However, often times, the action ends with the item sold at only a fraction of its true worth. Even worse, there is no control by the user to accept to reject the sale—once the time for the auction expires, the transaction has been completed.

There are trading websites, ie. www.tonystrading.co.uk, where a trade occurs, but it always occurs between the site's owner and one other member. Therefore the trades are always between two people. Also, there is a lack of automated inventory by the system which forces users to manually search through all items listed.

Other trade sites exist as well for specific types of items, but none of them allow for categorizing inventory that does not already have an existing identification number, allow for searching based on item attributes, actively match users whether they are signed-in or not, allow for a trade between more than two users, and allows for confirmation, rejection or negotiation of the trade. Therefore, the need exists for a system that allows for these online and offline capabilities amongst multiple users with a wide variety of items to trade for other items, cash or a combination of the two, while providing each user with control over the transaction.

### SUMMARY OF THE INVENTION

A system and method is disclosed for allowing users with access to the internet the ability to post any items they would like to offer by trade, propose a value for those offered items, search for items they would like to receive by trade, which may or may not be currently held in inventory, be notified when potential trades are available and accept or reject items they would like to receive by trade and confirm the trade with at least one other user. Additionally, the system will allow a user to make a direct purchase of items that have been specified as such.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an architectural cloud diagram of a prior art networked system that may be used for the present invention.

FIG. 2 illustrates an organizational chart of the system architecture of the preferred embodiment of the present invention.

FIG. 3 illustrates a flowchart of the specific user operations options that are available in the preferred embodiment of the present invention.

FIG. 4 illustrates a flowchart for matching operation in the preferred embodiment of the present invention.

FIG. 5 illustrates a format for the custom inventory system in the preferred embodiment of the present invention.

FIG. 6 illustrates a chart displaying possible trades between multiple users using the preferred embodiment of the present invention.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may still be utilized and structural and functional modifications may be made without departing from the scope and spirit of the present invention.

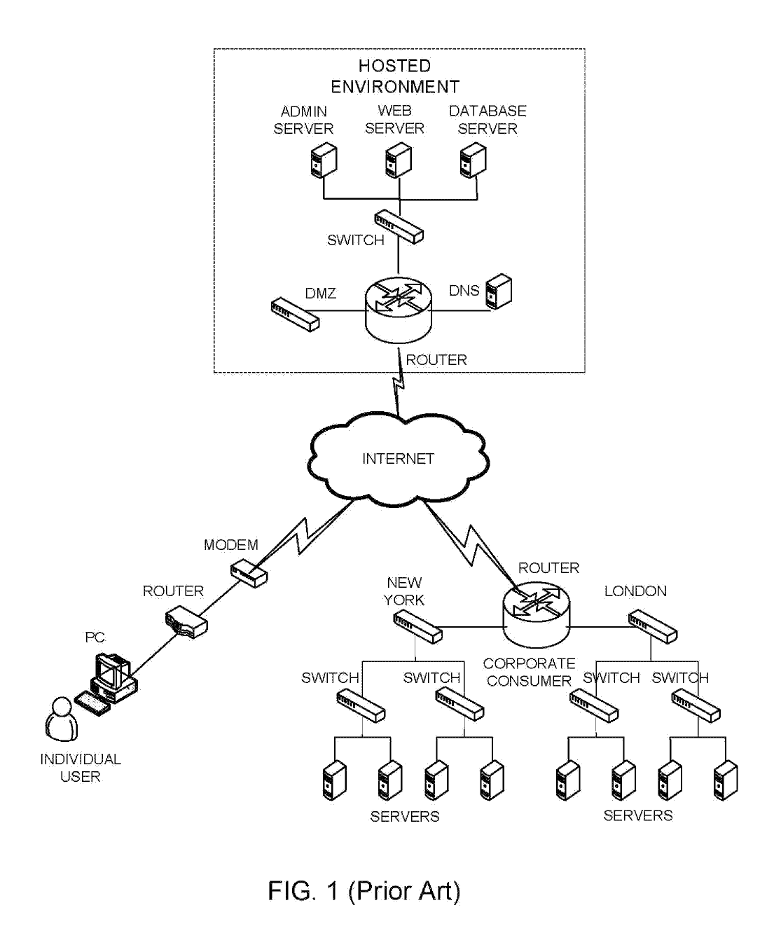

Referring to FIG. 1, an architectural cloud diagram of a prior art system is shown which may be used for the presently disclosed system and method. On a large scale, the hosted network environment is connected to individual servers in various cities as well as an individual user on a personal computer (“PC”) through the Internet. At its core, the hosted network consists of at least an administration server, a website server and a database server, each with their own memory and central processing units (“CPUs”) but intertwined by software programs that utilize information from all of the servers. The hosting network will also usually include a domain name server (“DNS”) and demilitarized zone (“DMZ”) as a perimeter security mechanism. The network can easily be connected by a combination of routers and/or switches to send information across the Internet. An individual user can then access and input information to the hosted network though modems and routers of their own or additional servers outside the network.

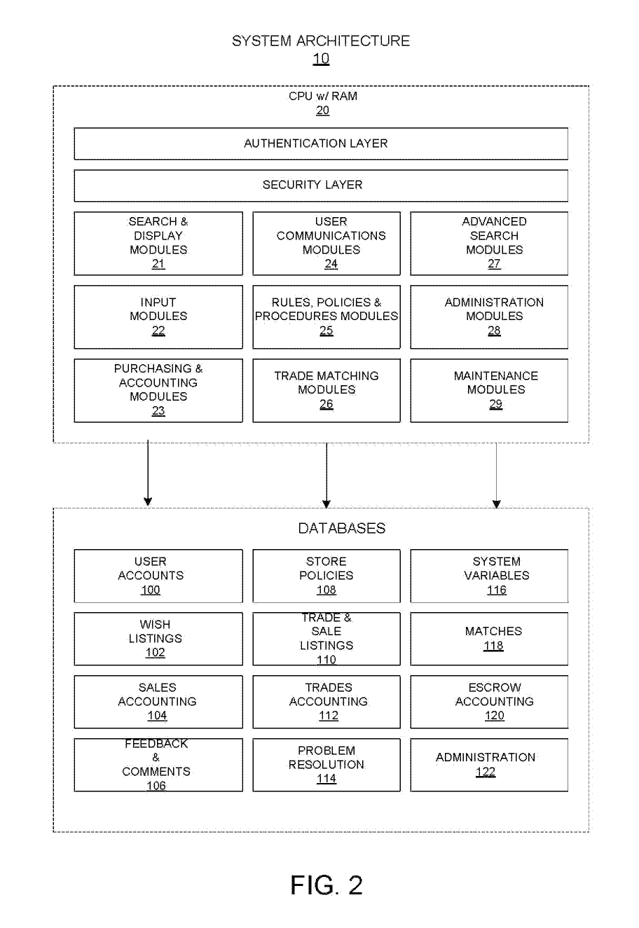

Now referring to FIG. 2, an organizational chart of the system architecture in the preferred embodiment of the present disclosure is shown. System architecture 10 is comprised of CPU 20 which runs random access memory (“RAM”) and controls a large assortment of individual operational modules. Surrounding all of the modules are at a minimum an authentication layer and security layer which assist in maintaining the integrity of the system. Under these layers are the modules themselves which comprise search and display modules 21; input modules 22; purchasing and accounting modules 23; user communications modules 24; rules, policies and procedures modules 25; trade matching modules 26; advanced search modules 27; administration modules 28; and system maintenance modules 29. Each module works with a combination of other modules and performs individual tasks which allow for the operation of the system and access a vast amount of information from individual databases within the system. The databases comprise user accounts 100; wishlists 102; sales accounts 104; feedback and comments 106; store policies 108; tradelists and sales lists 110; trade accounting 112; dispute and problem resolution 114; system variables 116; matches 118; escrow accounting 120 and administration 122. In the present disclosure, sales lists are a subset of tradelists and can be classified as such. Additionally, trade accounting 112 further comprises a monetary unit converter which allows the system to accept more than 50 different types of currency.

For the purposes of this disclosure, operation modules, referenced supra, may be located in the same location or may be housed or running from various locations. Additionally, system 10 may be controlled or operated locally or remotely. The security layer, used to prevent network attacks, such as denial of service, viruses, Trojans and intrusions, may further comprise a firewall, proxy server, antivirus, network monitor and around the clock surveillance. Also, in the preferred embodiment, certain configuration changes have been made to the operating system, programming environment and databases to exclude commands and functions that can be exploited for malicious purposes, including creation of separate libraries outside of the server root, user name and password requirements and the ability to implement security patch updates.

Wishlists 102 and tradelists 110 are comprised of items which a user would like to potentially accept and offer respectively. Items may be defined as physical tangible items, group of items, property, services and/or cash. Cash trades will typically be referred to as sales, where there may or may not be negotiation involved. In the preferred embodiment of the present disclosure, immediately upon adding an item to a wishlist, a user is shown the number, and possibly the username, of other members who have that wishlist item listed for trade or sale. The user is also able to see the details of that wishlist item, including the price suggested by the user that has the item listed for trade. After creating a wishlist, a user creates a tradelist by listing items they have for trade or sale. Each tradelist item may comprise a listing headline, a listing period for the length of time it will be “active” or available, listing priority, quantity, price, transaction type (e.g. trade only, trade or sale, sale only), individual item or set of items, disposition of proceeds (e.g. check mailed to user, deposit in PayPal® account, donate to charity, or put into escrow), condition of the item, and search keywords that allow another user the ability to find that item. If the listing is approved by the system, the item is immediately added to the inventory for participating in matching operation.

In the preferred embodiment, the matching process is continuous and occurs in both real time and in batch made. Real time is defined as when both users are signed in and actively using the system. Batch mode utilizes a scheduled process and is used when at least one of the users is not signed in, for example when the user that has a selected tradelist item is not currently online or using the system. Matching is the process of pairing members who have a particular item on a wishlist with users who have that particular item on a tradelist. This pairing can be arranged between two trading partners or between multiple trading partners who are users on the system.

When a match is identified, the system assigns a trade reference number to the match. The trade reference number may include the mailbox of each of the users for communication, negotiation and shipping purposes. The inventory potentially involved in the match is put into a temporary pending state, so that it can not be traded, purchased or sold during the time the trade is being negotiated. The system also informs the involved users of the match by notifying them of the trade reference number of the match and usernames of the other users. In the preferred embodiment of the present disclosure, system 10 will also generate a warning message if the difference in trade values, based on wishlist values, or wishlist value and trade price, is greater than 10%. In the case where a user is found that has multiple trade items that match another user's wishlist item, the system will automatically choose the item that is closest to the suggested value and send a notification to that effect. Notification may occur through various ways known in the art, such as email, instant messaging, SMS messaging, other forms of electronic text messaging, or video messaging. However, if all users involved in the trade are signed in the system may notify them through the system itself or simply display the match within a webpage.

Searching modules 21 and 27 work in different ways to allow users to conduct at least three types of searches. One is a random search, where a user can select a category or default to “All Categories” and type any search term into a search box. The second is an extensive menu system that is preprogrammed so that a user can enter an item or inventory number, described infra, and the system will perform an exact lookup for that term or number. The third type of search occurs when a user is entering items on their wishlist. In this case, they may enter not just a category or type of item, but also the attributes to an item. Attributes may comprise features, models, years, conditions and the like. Trade matching module 26 would then limit the search and only notify the user when a match based on those attributes is found. Most often, entering more attributes will narrow the search results and increase the amount of time required to find a potential match.

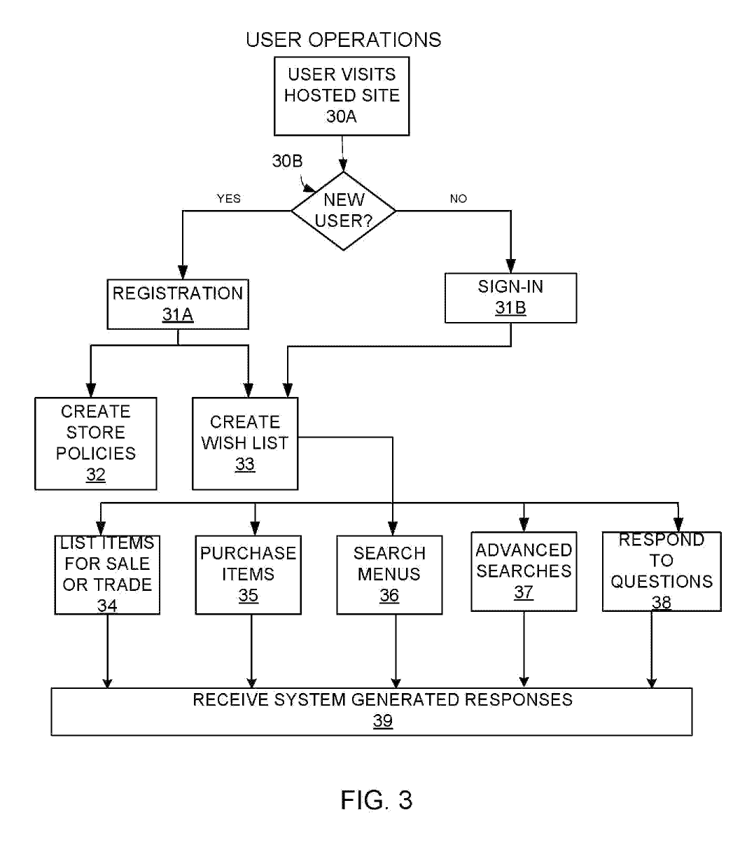

Now referring to FIG. 3, a flowchart of the specific user operations that are available in the preferred embodiment of the present disclosure is shown. At the first step, the user visits the hosted site 30A. The system outputs the query of whether the user is new to the system 30B and has previously registered. If not, the user is taken to registration 31A to input information that will be stored in user account database 100. The user then proceeds to step 32 to create store policies, such as shipping and handling policies, refund policies and payment policies, which are stored for that specific user in database 108, and is then provided with the option of creating a wishlist at step 33, which will be stored in database 102. If the user is returning to the system, the existing user signs in at step 31B and proceeds to create or modify their wishlist at step 33. After a user has created a wishlist, they will have the menu options of listing items for trade or sale 34, by creating a tradelist that will be stored under that specific user's account number in database 110, purchasing items 35, accessing searching menus 36, entering search terms and attributes by conducting advanced searches 37, or responding to online questions 38. The user will receive unique system generated responses 39 to specific actions within each of these individual menu options.

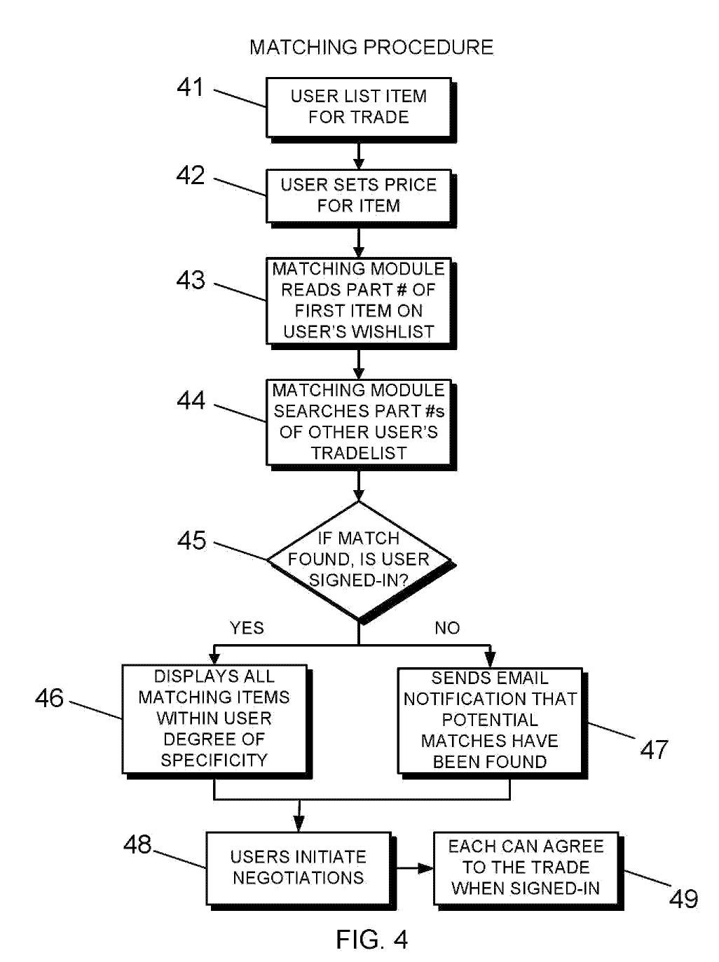

Now referring to FIG. 4, a flowchart of the system matching procedure is shown. At step 41, a user lists an item for trade which creates a tradelist. The user can list as many features or attributes about the item as desired and can input pictures or videos of the item as well. The system will generate a unique identifier or part number for each item as described in [0020] below. The user then sets the ask price for their item in step 42. In an alternate embodiment, the user can request system 10 to generate an ask price, based on the part number, with associated attribute. In the present disclosure, an ask price may also be referred to as a sell price, a suggested price or simply a price. In step 43, the system trade matching modules 26 reads the part number of the first item on the user's wishlist. In step 44, the matching module 26 then searches the part numbers of other user's tradelists. If the second user's tradelist contains an item in the first user's wishlist and the second user's wishlist contains an item in the first user's tradelist, a match is found. If a match is found, at query 45, the system asks whether both users are currently signed-in to the system. If so, the search and display modules display all matching items within the user's degree of specificity at step 46. As mentioned previously, the system may also identify the trade item that has a suggested value closest in price to the suggested value of the wishlist item. Moving beyond FIG. 4 by way of written description, if the first user's tradelist does not contain an item in the second users wishlist, the search module moves on to find a third user whose tradelist contains an item in the second user's wishlist and whose wishlist contains an item in the first user's tradelist. This creates the potential three-way match. The presently described scenario is only used as an example as it should be recognized that this type of matching could proceed indefinitely with more than three users and even multiple items between the same users. At step 47, the system communication modules 24 sends a notification to both users, or all users involved, that potential matches have been found. In the preferred embodiment, the notification will include the match reference number, stored in database 118 and a mailbox number for each user, stored in database 100. The mailbox number is assigned to a user at registration in order for anonymous communication between user to occur, mainly during negotiation and shipping. After display or notification, the users that have been matched can initiate negotiations either within the system or externally through email in step 48. One aspect of the negotiations is whether the users would like to use an escrow system of delivery. This allows for items to be kept by a neutral third party until payment is received from each user. Payment and items are then sent and shipped by the third party. This novel aspect to online bartering systems is important when the goods involved possess a high value. After all negotiated terms have been reached, each user can then agree to the negotiated trade after signing back in to the system 49.

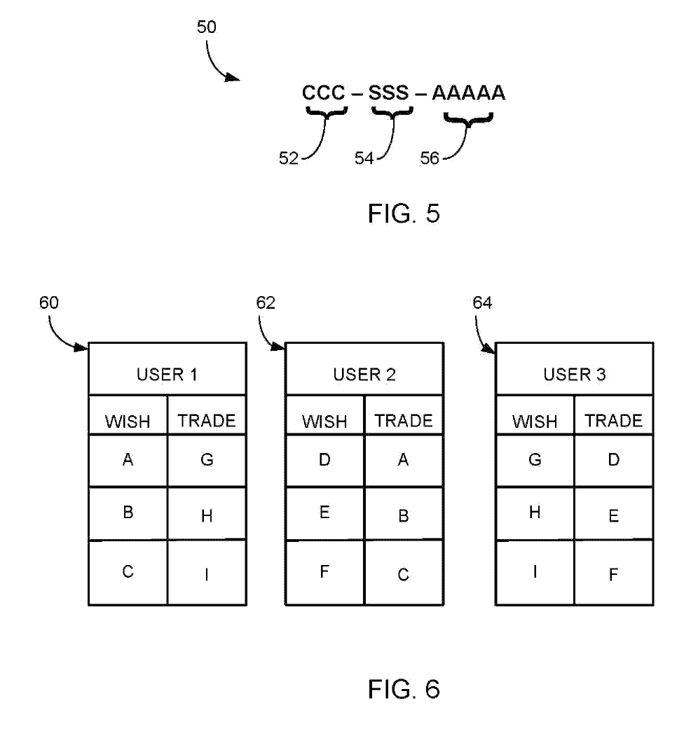

Now referring to FIG. 5, a format for the custom inventory system of the present disclosure is shown. Part number 50 consists of a three-digit main category number 52, followed by a three-digit subcategory number 54, followed by a five-digit attribute number 56. Part number 50 can therefore be unique to any item entered into system 10. Using these three categories any make model and description of item can be classified. In one embodiment, for example main category 52 may represent baby products, cameras or vehicles; sub category 54 may represent boats, cars or motorcycles; and attribute 56 may represent sports sedan, BMW®, high mileage or sunroof. All attributes are entered into system 10 by a user, but then the system converts the description into unique identifying part number 50 so that items on a wishlist or tradelist may easily be accessed, read, stored, matched and/or displayed. The inventory system is preferably internal and allows for dissimilar items such as a washing machine and a refrigerator can be traded for each other, even though neither has a physical identification number.

Now referring to FIG. 6, a chart displaying possible trades between three users is shown. In this exemplary embodiment, user 60 has three items, A, B and C on her wishlist, and three items, G, H and I on her tradelist. User 62 has three items, D, E, and F in his wishlist and three items A, B and C on his tradelist. User 64 has three items, G, H and I on his wishlist and three items, D, E and F on his tradelist. From this figure, it can be seen that user 62 could for example trade item B to user 60, user 64 could trade item D to user 62, and user 60 could trade item I to user 64, as long as all agree the trade is fair. System 10 allows for this to happen utilizing a novel listing procedure, inventory system, searching procedure, matching procedure, matching notification and trading negotiation process.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described apparatus and techniques. Thus, the spirit and scope of the invention should be construed broadly as set forth in the appended claims.

What is claimed is:

1. A method for matching multiple users that have signed in to a computer on a computer network comprising the steps of:
posting an unwanted first item for trade on a local computer of a first user;
assigning a trade value for said first item;
creating a first wishlist of said first user comprising at least a second item;
assigning a first user number and a first part number to said first item, said first part number further comprising a category prefix and an attribute suffix;
using a searching module on a remote server to search a tradelist database for said second item;
creating and storing a list of second users with said second item;
using said search module to search a second wishlist of said second users for said first item;
matching one of said second users with said second item and said first user with said first item and assigning a trade reference number; and
displaying said trade reference number and said second item to said first user and said trade reference number and said first item to said one of said second users.

2. The method of claim 1, wherein at least one of said multiple users signed on to said network via a wireless device.

3. The method of claim 1, wherein said first item or said second item comprises a service.

4. The method of claim 1, wherein said first item or said second item comprises cash.

5. The method of claim 1, wherein said trade value for said first item is generated by said first user.

6. The method of claim 1, wherein said trade value for said first item is generated by a processor within said network.

7. The method of claim 1, wherein said second item has already been assigned a second user number and a second part number.

8. The method of claim 7, wherein searching said tradelist database for said second part number is based on said second part number.

9. The method of claim 1, wherein said trade reference number includes a mailbox number of said first user and said one of said second users.

10. The method of claim 1, wherein displaying said trade reference number and said second item to said first user and said trade reference number and said first item to said one of said second users occurs via electronic mail or SMS messaging.

11. A method for matching multiple users that have signed in to a computer on a computer network comprising the steps of:
posting an unwanted first item for trade on a local computer of a first user;
assigning a trade value for said first item;
creating a first wishlist comprising at least a second item;
assigning a first user number and a first part number to said first item, said first part number further comprising a category prefix and an attribute suffix;
using a searching module on a remote server to search a tradelist database for said second item;
creating and storing a list of second users with said second item;
using said search module to search a second wishlist of said second users for said first item;
using said search module to search said tradelist database for a third item on said second wishlist;
creating and storing a list of third users with said third item;
using said search module to search a third wishlist of said third user for said first item; and
matching one of said third users with said third item and one of said second user with said second item and said first user with said first item and assigning a trade reference number; and
notifying said first user, said one of said second users and said one of said third users of the trade reference number.

12. The method of claim 11, wherein at least one of said multiple users signed on to said network via a wireless device.

13. The method of claim 11, wherein said first item, said second item or said third item comprises a service.

14. The method of claim 11, wherein said first item, said second item or said third item comprises cash.

15. The method of claim 11, wherein said trade value for said first item is generated by said first user.

16. The method of claim 11, wherein said trade value for said first item is generated by a processor within said network.

17. The method of claim 11, wherein said second item has already been assigned a second user number and a second part number, and said third item has already been assigned a third user number and a third part number.

18. The method of claim 17, wherein searching said tradelist database for said second part number is based on said second part number and searching said tradelist database for said third item is based on said third part number.

19. The method of claim 11, wherein said trade reference number includes a mailbox number of said first user, said one of said second users and said one of said third users.

20. An inventory system for a computer networked matching system comprising a three digit category number followed by a three digit subcategory number followed by a five digit attribute number.
